(19) United States
(12) Patent Application Publication
(10) Pub. No.: US 2004/0124166 A1
(43) Pub. Date: Jul. 1, 2004

(54) Mobile crane substructure

(76) Inventors: Hans-Dieter Willim, Ulm-Unterweiler (DE); Uwe Frommelt, Ehingen (DE)

Correspondence Address: Rocco S. Barrese, Esq., DILWORTH & BARRESE, LLP, 333 Earle Ovington Blvd., Uniondale, NY, 11553, US

(21) Appl. No.: 10/734,455

(22) Filed: Dec. 12, 2003

(30) Foreign Application Priority Data
Dec. 12, 2002 (DE) UM 20219299.7

(51) Int. Cl. B66C 23/44

(52) U.S. Cl. 212/181

(57) ABSTRACT

The present invention relates to a mobile crane substructure with a crawler travel gear arrangement comprising a chassis frame and four individual crawler travel gear elements which are held on bearings located on the chassis frame. According to the invention, the mobile crane substructure is characterised in that the chassis frame comprises two transverse through-girders, with one of the individual crawler gear elements being attached at each end of said transverse through-girders, and in that said chassis frame further comprises a centre section of the frame, which centre section interconnects the two transverse girders.

The present invention relates to a mobile crane substructure with a crawler travel gear arrangement comprising a chassis frame and four individual crawler travel gear elements which are held on bearings located on the chassis frame.

Large cranes such as derrick cranes often comprise crawler travel gear arrangements, so as to ensure better distribution of the substantial weight forces experienced, and so as to avoid exceeding permissible surface pressures. However, these crawler travel gear arrangements pose problems for the transport of such cranes. In some cases, each of the crawler gear elements is so heavy that it cannot be loaded and transported in one piece. Each crawler gear element must therefore be dismantled which often requires opening the crawler chain.

Crawler travel gear arrangements have been proposed which instead of comprising the usual two continuous crawler chains, one on the left and one on the right side, comprise four individual crawler gear elements by which the crane is supported, not unlike the way a car is supported by its four wheels. The individual crawler gear elements can be dismantled individually. They are considerably less heavy when compared to continuous crawler gear elements, so that they can be loaded and transported individually without the need for dismantling. However, such crawler travel gear arrangements comprising four individual crawler gear elements pose a problem in that their chassis frames become unstable and are subjected to very considerable torsional deformation forces.

It is thus the object of the invention to provide an improved mobile crane substructure of the type mentioned in the introduction, which mobile crane substructure overcomes the disadvantages of the state of the art, and advantageously improves said state of the art. Preferably, a mobile crane substructure of very good torsional rigidity is to be designed, which is easy to dismantle for the purpose of transport.

According to the invention, this object is met by a mobile crane substructure according to claim 1. Preferred embodiments of the invention are disclosed in the subordinate claims.

According to the invention, the chassis frame of the mobile crane substructure thus comprises two transverse through-girders, with one of the four individual crawler gear elements being attached at the ends of each of said transverse through-girders, and further comprises a centre section of the frame, which centre section interconnects the two transverse through-girders. There is thus no unstable chassis frame design involving a multiple number of individual girders. The two transverse through-girders as well as the centre section of the frame which connects said transverse through-girders form a compact and rigid structure. In particular, the arrangement does not involve longitudinal girders which lead from the centre section of the frame or from the transverse girders, with the ends of said longitudinal girders comprising the individual crawler gear elements or additional transverse girders to which the individual crawler gear elements are then attached. The chassis frame is designed in a simple way comprising essentially three parts. The individual crawler gear elements are directly attached to the projecting ends of the transverse girders.

In order to simplify transport while at the same time keeping within the maximum loads permissible for road traffic, the individual crawler gear elements are detachably attached, in particular bolted on, to the transverse girders. Because no continuous crawler gear elements are provided on the right and on the left, but instead, four individual crawler gear elements, it is not necessary to dismantle the individual crawler gear elements since the overall weight of each of them is sufficiently light for it to be transported in one piece.

In an improvement of the invention, the individual crawler gear elements are rigidly attached to the transverse girders, i.e. they are not movably held on bearings by a steering suspension or the like. Thus, the tipping edges of the crane at the front and at the rear coincides with the first and last roller, respectively, of the travel gear.

Preferably, the transverse girders act as torsion bars so that a favourable surface pressure can be achieved even if the ground is not flat. If the crane travels over a bump in the ground, the individual crawler gear elements can adjust by torsion of the transverse girders and thus by a swivel movement on the transverse axis defined by the transverse girders, so as to compensate for the bump in the ground.

Furthermore, the transverse girders can also be detachably attached, in particular bolted on, to the centre section of the frame. In this way, for the purpose of transport, dismantling of the mobile crane substructure is still further simplified.

In order to achieve a stable connection between the transverse girders and the centre section of the frame, the centre section of the frame can comprise laterally extending, vertical, longitudinal plates which are interconnected by transverse profiles and which protrude in longitudinal direction beyond said transverse profiles. The protruding sections of the longitudinal plates can be seated between fork-shaped bearing lugs provided on the transverse girders, and can be bolted to said fork-shaped bearing lugs. Preferably, however, each of the vertical longitudinal plates is bolted to the transverse girder at the upper and lower margin of said transverse girder.

The transverse girders can be essentially straight and extend at right angles in relation to the direction of travel of the crawler gear elements. Preferably, the crawler gear elements are arranged on the transverse girders such that in each case the axis defined by the transverse girder is approximately in the centre in relation to the rotary movement defined by the respective crawler chain.

The centre section of the frame, which centre section connects the two transverse girders, supports a pivot bearing in a way known per se, in particular a live ring on which the superstructure of the mobile crane is held so as to be rotatable on an upright axis. Preferably, the centre section of the frame and the transverse girders are each designed as a steel-plate box profile.

According to a preferred embodiment of the invention, the individual crawler gear elements are arranged in two tracks, i.e. they are arranged in pairs, one behind the other. In principle, each individual crawler gear arrangement could be designed as a double crawler chain element, i.e. it could comprise two crawler chains, one aligned parallel to the other. Preferably however, each individual crawler gear element comprises only a single crawler chain.

Below, the invention is explained in more detail with reference to a preferred embodiment and an associated drawing. The drawing shows the following:

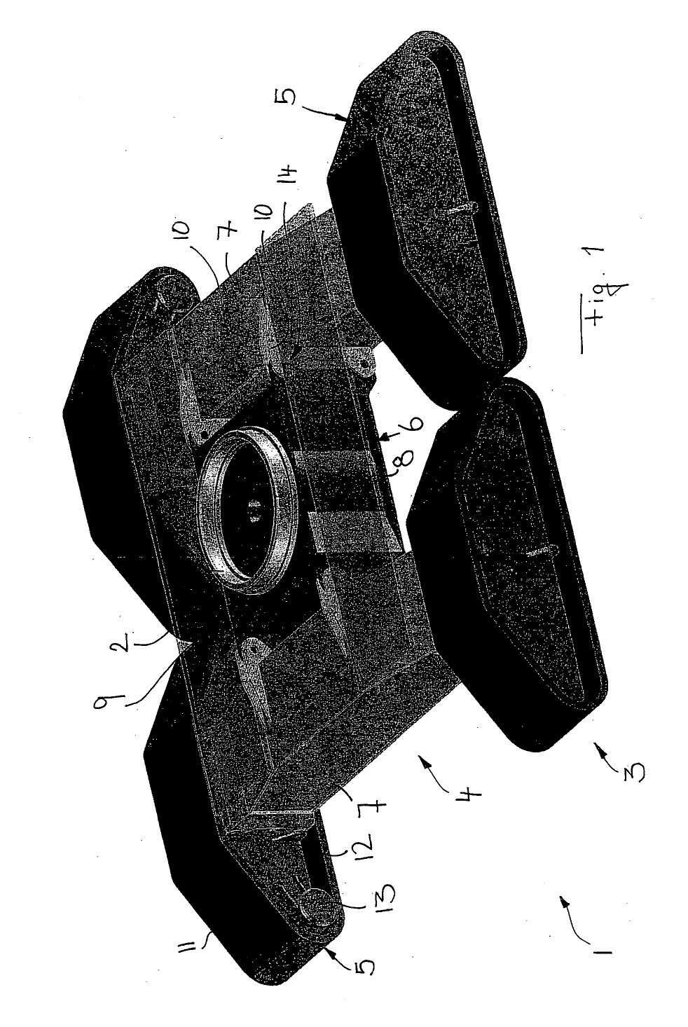

FIG. 1 a perspective view of a mobile crane substructure according to a preferred embodiment of the invention.

The mobile crane substructure 1 which is shown in the Figure can carry the superstructure (not shown in detail) of a derrick crane, which superstructure is carried by the mobile crane substructure 1 so as to be rotational on an upright axis. On the mobile crane substructure 1, the bearing ring 2 of a corresponding pivot bearing is shown.

The mobile crane substructure 1 comprises a crawler travel gear arrangement 3 which comprises a chassis frame 4 which, on respective bearings, holds four individual crawler gear elements 5. In this arrangement, two individual crawler gear elements 5 are arranged in one track, one behind the other, with one such arrangement on the left hand side and the other on the right hand side. In other words, a normal, continuous crawler gear element is divided into two individual crawler gear elements 5.

The chassis frame 4 comprises a centre section 6 of the frame, with a transverse through-girder 7 each being rigidly attached to the front and rear end of said centre section 6 of the frame. The two transverse girders 7 extend at right angles to the direction of travel of the mobile crane substructure 1; they are essentially straight girders. As shown in the Figure, on the right and on the left, the transverse girders 7 project some distance beyond the centre section 6 of the frame. The span of the transverse girder 7 can correspond to approx. two to three times the width of the centre section of the frame.

As shown in FIG. 1, the outer flanks of the centre section 6 of the frame comprise vertically-aligned plate-shaped longitudinal girders 8 which are interconnected by transverse girders 9. In this arrangement, the longitudinal girders 8 protrude beyond the transverse plates 9. In this arrangement, the protruding girder sections 9 are positioned between fork-shaped bearing plates 10, of which a pair is provided on each of the transverse girders 7 where they project towards the centre section 6 of the frame. In this arrangement, the bearing plates 10 form fork-shaped bearing lugs 11 which are positioned approximately on the top and bottom of the transverse girders 7 where they can be bolted to the projecting sections of the longitudinal girders 8 of the centre section 6 of the frame. In this way, a rigid and stable connection between the transverse girders 7 and the centre section of the frame 6 can be achieved.

At the projecting ends of the transverse girders 7, the crawler gear elements 5 are detachably attached in a corresponding manner, i.e. bolted on. The transverse girders 7 comprise bearing plates which are spaced apart from each other and which project at the face, with said bearing plates being seated in fork-shaped bearing lugs of the crawler gear elements 5, and being bolted to said fork-shaped bearing lugs (compare FIG. 1).

As shown in FIG. 1, each transverse girder 7 forms a steel-plate box profile of closed cross-section, with a very favourable ratio of rigidity to weight resulting thereof.

The centre section 6 of the frame can also be a steel-plate box profile.

Each individual crawler gear element 5 comprises a crawler chain 11 which runs in a rotary movement on a chain guide 12. Each crawler gear element 5 comprises a separate drive 13.

1. A mobile crane substructure with a crawler travel gear arrangement (3) comprising a chassis frame (4) and four individual crawler travel gear elements (5) which are held on bearings located on the chassis frame (4), characterised in that the chassis frame (4) comprises two transverse through-girders (7), with one of the individual crawler gear elements (5) being attached at each end of said transverse through-girders (7), and in that said chassis frame (4) further comprises a centre section (6) of the frame, which centre section (6) interconnects the two transverse girders (7).

2. The mobile crane substructure according to the preceding claim, wherein the individual crawler gear elements (5) are detachably attached, in particular bolted on, to the transverse girders (7).

3. The mobile crane substructure according to one of the preceding claims, wherein the transverse girders (7) are detachably attached, in particular bolted on, to the centre section (6) of the frame.

4. The mobile crane substructure according to any one of the preceding claims, wherein the individual crawler gear elements (5) are rigidly attached to the transverse girders (7), and wherein the transverse girders (7) are preferably torsion bars.

5. The mobile crane substructure according to any one of the preceding claims, wherein the centre section (6) of the frame supports a pivot bearing (2), in particular a live ring, on which the superstructure of the mobile crane is held so as to be rotatable on an upright axis.

6. The mobile crane substructure according to any one of the preceding claims, wherein the transverse girders (7) are essentially straight and extend at right angles to the direction of travel of the crawler gear elements (5).

7. The mobile crane substructure according to any one of the preceding claims, wherein the transverse girders (7) and/or the centre section (6) of the frame are/is each designed as a steel-plate box profile.

8. The mobile crane substructure according to any one of the preceding claims, wherein the centre section (6) of the frame comprises plate-shaped, laterally extending, vertical, longitudinal girders (8) which are interconnected by transverse profiles (9) and which protrude in longitudinal direction beyond said transverse profiles (9), wherein fork-shaped bearing lugs (14) are provided on the transverse girders (7), with the protruding plate-shaped longitudinal girders (8) of the centre section (6) of the frame being seated between said fork-shaped bearing lugs (14), and with said longitudinal girders (8) being bolted to said fork-shaped bearing lugs (14).

9. The mobile crane substructure according to any one of the preceding claims, wherein the individual crawler gear elements (5) are arranged in two tracks.
